(19) United States
(12) Patent Application Publication
(10) Pub. No.: US 2008/0107474 A1
(43) Pub. Date: May 8, 2008

(54) STRUCTURE OF CONTAINER FOR APPLYING LIQUID

(76) Inventor: Jun-Che Hsieh, Taipei City (TW)

Correspondence Address: SINORICA, LLC, 528 FALLSGROVE DRIVE, ROCKVILLE, MD, 20850, US

(21) Appl. No.: 11/551,788

(22) Filed: Oct. 23, 2006

(51) Int. Cl. B43K 7/10; B43M 11/02; B43K 7/00

(52) U.S. Cl. 401/216; 401/219; 401/209

(57) ABSTRACT

An improved structure of applying container including a bottle to receive liquid for applying, the bottle is provided thereon with a connecting seat that has on its top a ball seat for a rollable ball. A displacement means and a stop means are provided between the connecting seat and the ball seat. The displacement means endues the ball seat and the connecting seat with a first kind of relative position after displacement and a second kind of relative position after displacement. When the connecting seat and the ball seat are in the first relative position, the stop means forms a closing state, the liquid for applying in the bottle is prevented from flowing out of the ball, by contact of the rollable ball with skin, a massaging function can be obtained. When the displacement means makes the connecting seat and the ball seat be in the second relative position, the stop means is opened, thus the liquid in the bottle flows through the connecting seat to the ball at the top of the ball seat and flows outwards, thereby an applying function is obtained.

### BACKGROUND OF THE INVENTION

1. Field of the Invention

The present invention relates to an improved structure of container for applying liquid, and especially to an improved structure of container used for applying liquids such as emulsion, liquid medicine, liquid for applying to eliminate pain etc., the container can be used as a massaging tool when not being used for applying liquid.

2. Description of the Prior Art

Containers for applying liquid sold in the markets such as a container for applying liquid to eliminate pain etc. mostly has a bottle to receive liquid for applying, and the bottle is provided thereabove with an applying head that can make the liquid for applying flow out slowly and suitable for contact with skin; with the bottle held upside down and being pressed, the liquid for applying can flow from inside of the bottle toward the applying head.

An applying head with a known structure has a ball seat, a rotatable ball is provided on the end of the applying head for the purpose that the liquid for applying can flow through the ball and can be comfortably applied on the surface of skin. Such a conventional applying container can only be used as an applying container and has no other function. Therefore, it is the main category for discussion in the present invention that whether an applying container can have a function of massaging in addition to the function of applying liquid by designing a structure on the applying container.

### SUMMARY OF THE INVENTION

The present invention provides an improved structure of applying container, the applying container includes a bottle to receive liquid for applying; the bottle is provided thereon with a connecting seat that has on its top a ball seat for a rollable ball. A displacement means and a stop means are provided between the connecting seat and the ball seat. The displacement means endues the ball seat and the connecting seat with a first kind of relative position after displacement and a second kind of relative position after displacement. When the connecting seat and the ball seat are in the first relative position, the stop means forms a closing state, then the liquid for applying in the bottle is prevented from flowing out of the ball, by contact of the rollable ball with skin, a massaging function can be obtained. When the displacement means makes the connecting seat and the ball seat be in the second relative position, the stop means is opened, thus the liquid for applying in the bottle flows through the connecting seat to the ball at the top of the ball seat and flows outwards, and thereby an applying function is obtained.

The present invention provides an applying container with a massaging function, wherein the connecting seat has a protruding top seat, the ball seat has on its bottom a slipping-over cover which is slipped over the protruding top seat to allow rotation on the latter; the outer wall of the protruding top seat and the inner wall of the slipping-over cover are provided respectively with an upper inclining rib and a lower inclining rib, the upper inclining rib of the protruding top seat has a bottom inclining surface, while the lower inclining rib of the slipping-over cover has a top inclining surface for contact with the bottom inclining surface; by contact and moving of the top and the bottom inclining surfaces, the connecting seat and the ball seat can get the above stated first and second relative position after displacement.

The applying container with the massaging function provided in the present invention further includes a position limiting means provided between the connecting seat and the ball seat, it is used to limit the difference in distance of the first kind relative position from the second kind of relative position to prevent loosening and dropping of the connecting seat from the ball seat.

The present invention further is provided between the connecting seat and the ball seat that are rotatable to each other with a positioning means, the positioning means renders the ball seat to rotate and open the stop means for positioning the ball seat to do the liquid applying action, and can prevent lowering of the ball seat by the pressure created when the ball contacts the area to be applied with liquid.

The present invention will be apparent in its structure and operational functions after reading the detailed description of the preferred embodiment thereof in reference to the accompanying drawings.

### BRIEF DESCRIPTION OF THE DRAWINGS

FIG. 1 is an anatomized perspective view of the present invention;

FIG. 2 is a perspective view of the present invention being partially assembled;

FIG. 3 is a perspective view of the present invention after being assembled;

FIG. 4 is a sectional view of the present invention after being assembled;

FIG. 5 is a sectional view of the present invention of which a cover is removed;

FIG. 5A is an enlarged sectional view of the present invention with a connecting seat, a ball seat and a ball, wherein a displacement means makes a first kind of relative position after displacement;

FIG. 6 is similar to FIG. 5, wherein the ball seat has been raised;

FIG. 6A is an enlarged sectional view of the present invention with the connecting seat, the ball seat and the ball, wherein the displacement means makes a second kind of relative position after displacement;

FIG. 7 is a sectional view of the ball seat of the present invention;

FIG. 8 is a sectional view of the connecting seat of the present invention;

FIG. 9 is a top view of the connecting seat of the present invention;

FIG. 10 is a plan view of the connecting seat of the present invention;

FIG. 11 is a schematic plan view showing the present invention is used for the function of liquid applying;

FIG. 12 is a schematic plan view showing the present invention is used for the function of massaging.

### DETAILED DESCRIPTION OF THE PREFERRED EMBODIMENT

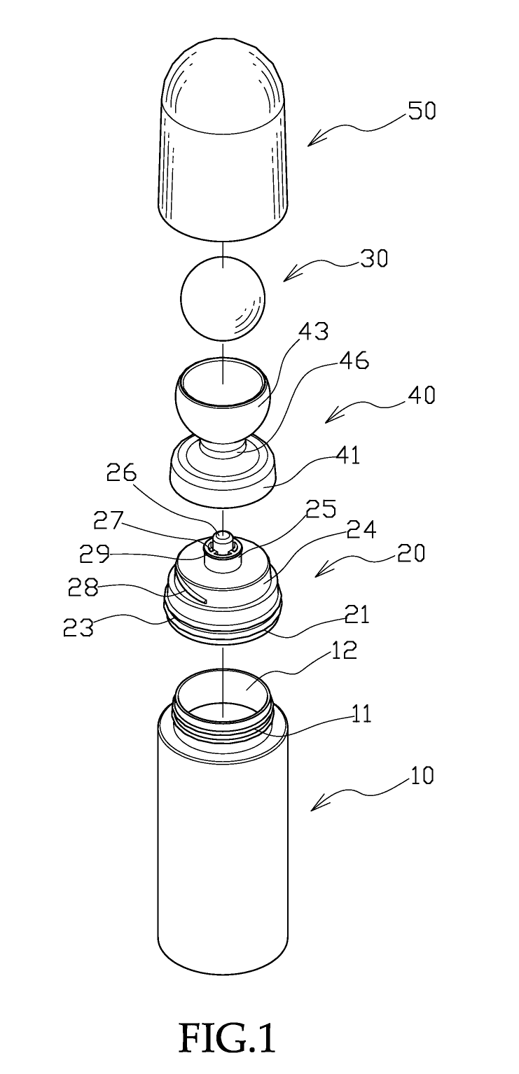

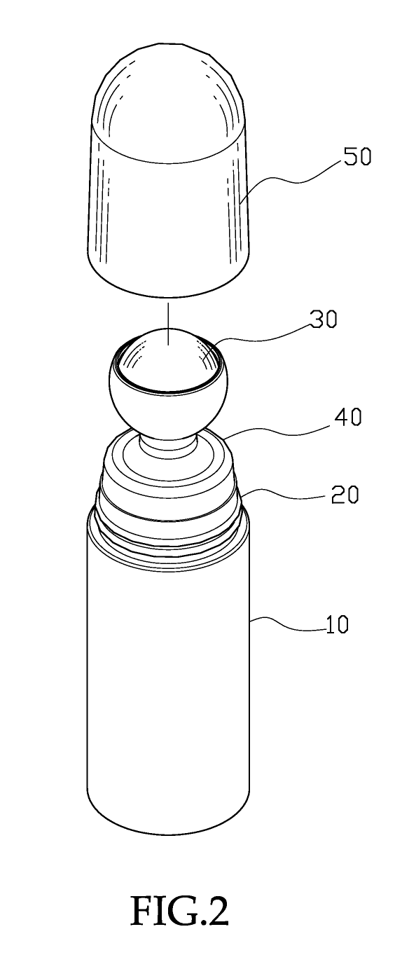

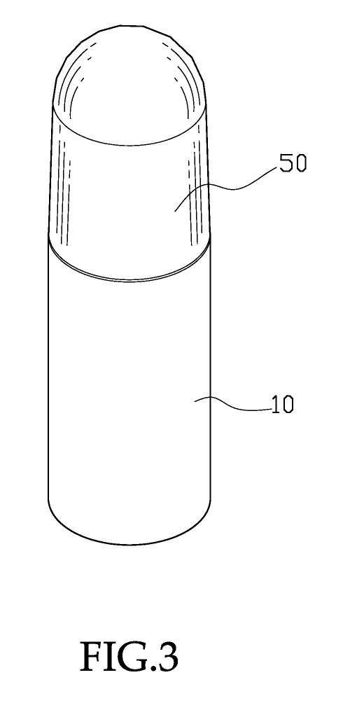

Referring to FIGS. 1-4, the applying container of the present invention has a bottle 10 to receive liquid for applying, the bottle 10 is provided thereon with a connecting seat 20 that has on its top a ball seat 40 for a rollable ball 30. A cap 50 covers the ball seat 40 and the connecting seat 20.

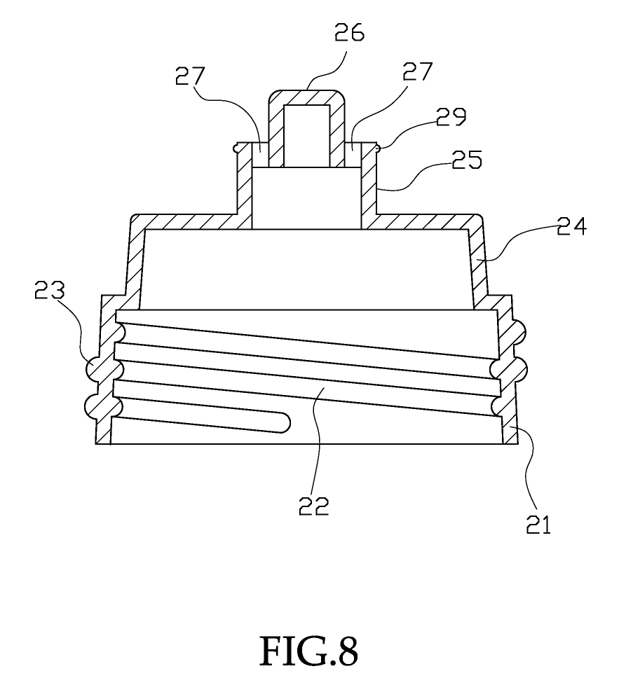

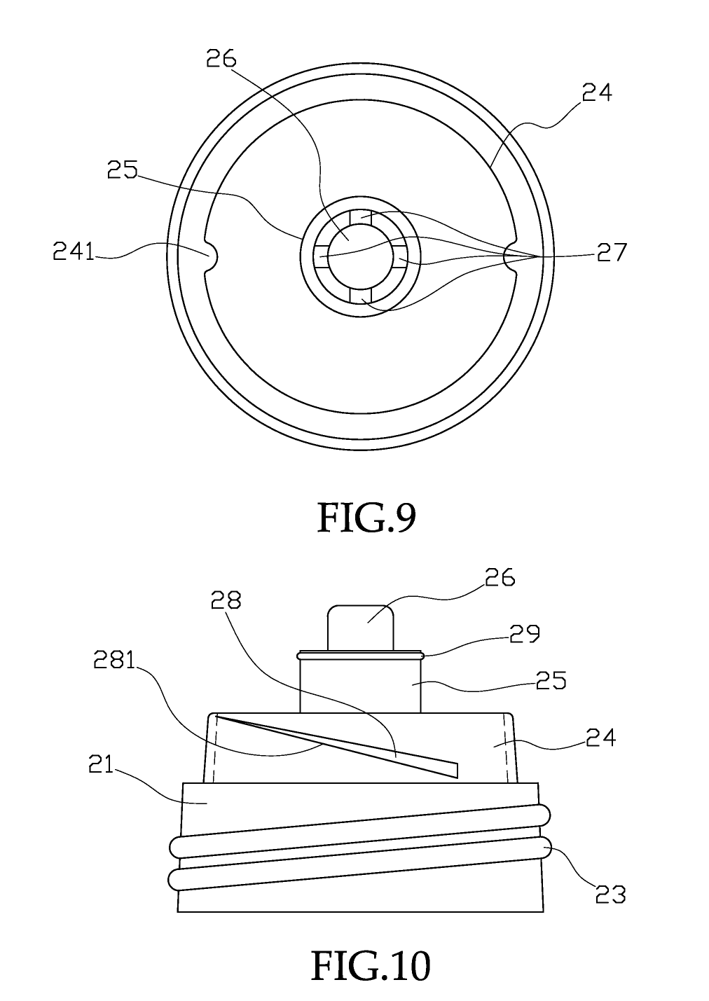

The bottle 10 has on its upper end a thread portion 11 for screw connecting with an inner thread 22 of the connecting seat 20 to cover an opening 12 on the top of the bottle 10. Referring to FIGS. 8-10, the inner thread 22 is provided on an inner wall of a base 21 of the connecting seat 20, while the base 21 further has an outer thread 23 provided on its outer wall. The base 21 has a protruding top seat 24 with a smaller diameter, the protruding top seat 24 is provided thereon with a pair of positioning cuts 241 (shown in FIG. 9); the protruding top seat 24 is formed thereon a nozzle 25 with an even smaller diameter on which a stop post 26 is provided. The stop post 26 and the nozzle 25 are formed therebetween a plurality of through holes 27 functioning as passages of liquid for applying. The outer wall of the protruding top seat 24 is formed an upper inclining rib 28; the upper inclining rib 28 has a bottom inclining surface 281 (referring to FIG. 10). The nozzle 25 has on its top end a circle of stop annulus 29.

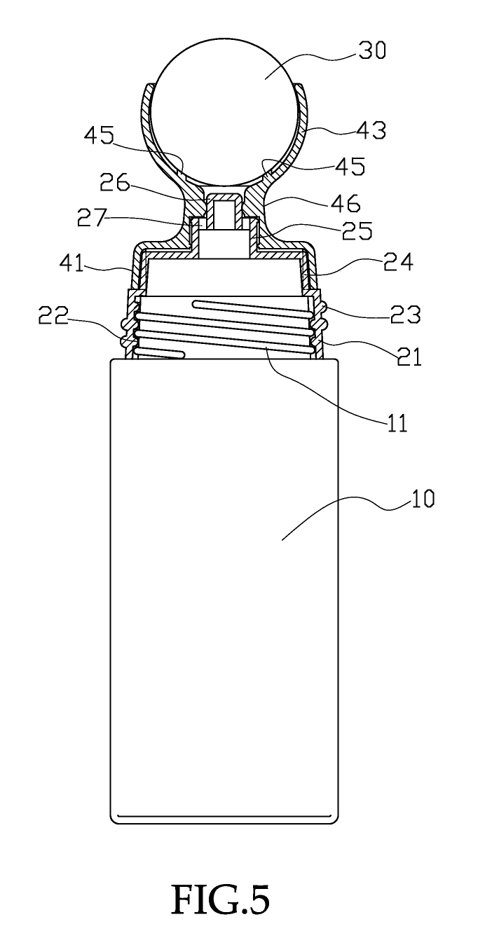

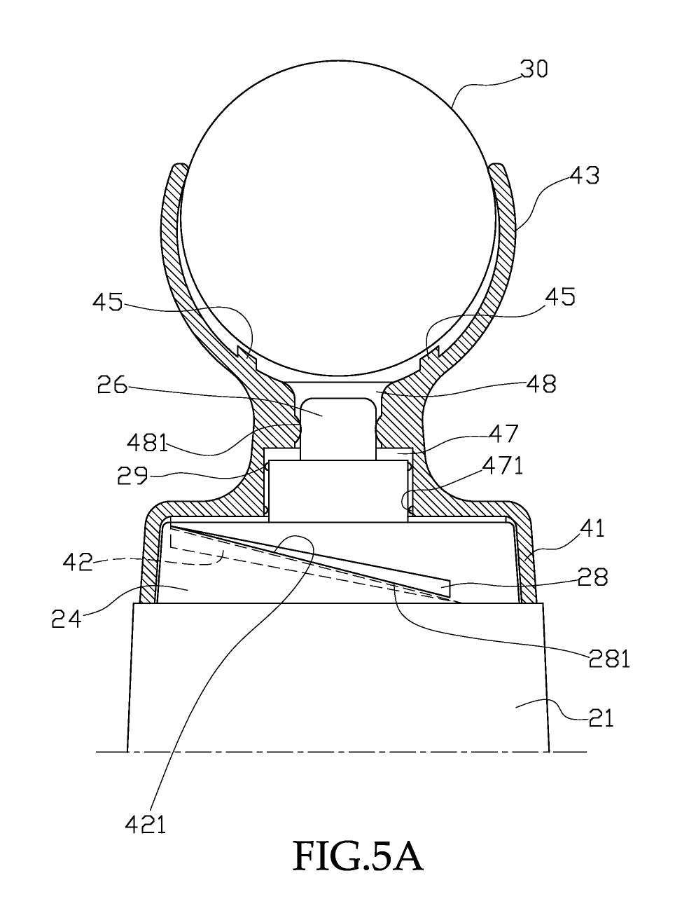

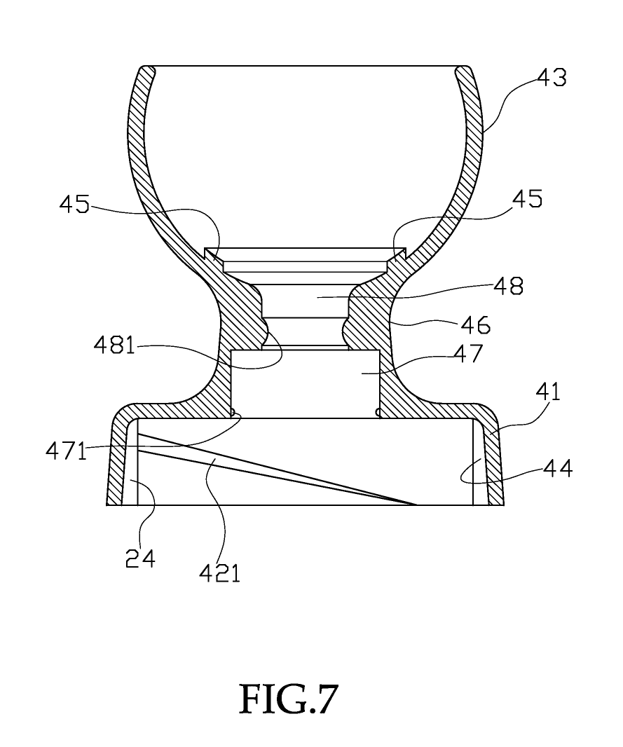

The ball seat 40, referring to FIG. 7, has on its bottom a slipping-over cover 41 which is slipped over the protruding top seat 24 of the connecting seat 20; the slipping-over cover 41 is provided on its inner wall with a lower inclining rib 42, the lower inclining rib 42 has a top inclining surface 421; the top inclining surface 421 can contact with the bottom inclining surface 281 on the upper inclining rib 28 of the protruding top seat 24 (referring to FIG. 5A), a displacement means can be formed from the upper inclining rib 28 and the lower inclining rib 42. The slipping-over cover 41 is further provided on its inner wall with two soft positioning blocks 44 which form a positioning means together with the pair of positioning cuts 241 of the protruding top seat 24.

The ball seat 40 has a ball receiver 43 in the form of a hopper, the interior of the ball receiver 43 can hold more than half of the ball 30, so that the ball 30 can be received in the ball receiver 43 in a rolling mode with a remaining part thereof being exposed out of the ball receiver. The hopper like ball receiver 43 has a pair of supporting protrusions 45 allocated symmetrically for supporting the bottom surface of the ball 30 to keep the latter from sticking to the ball receiver 43; this is shown in FIG. 5.

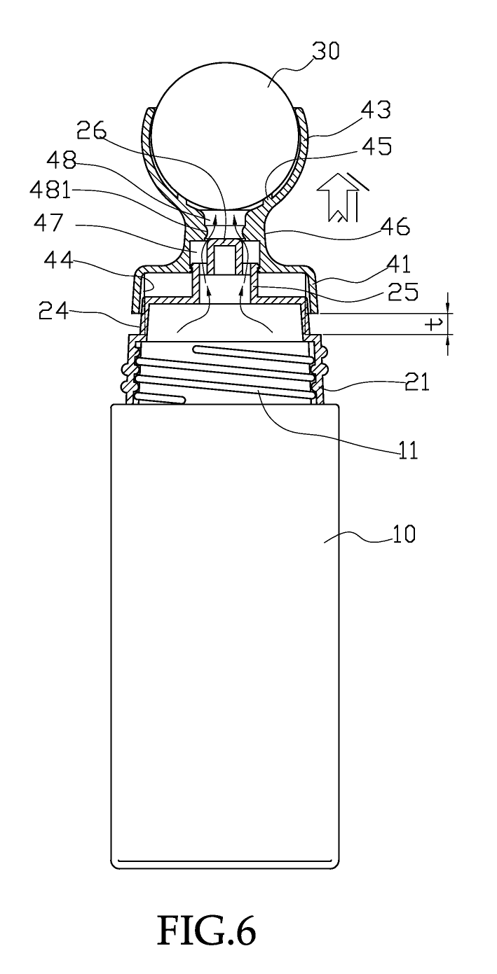

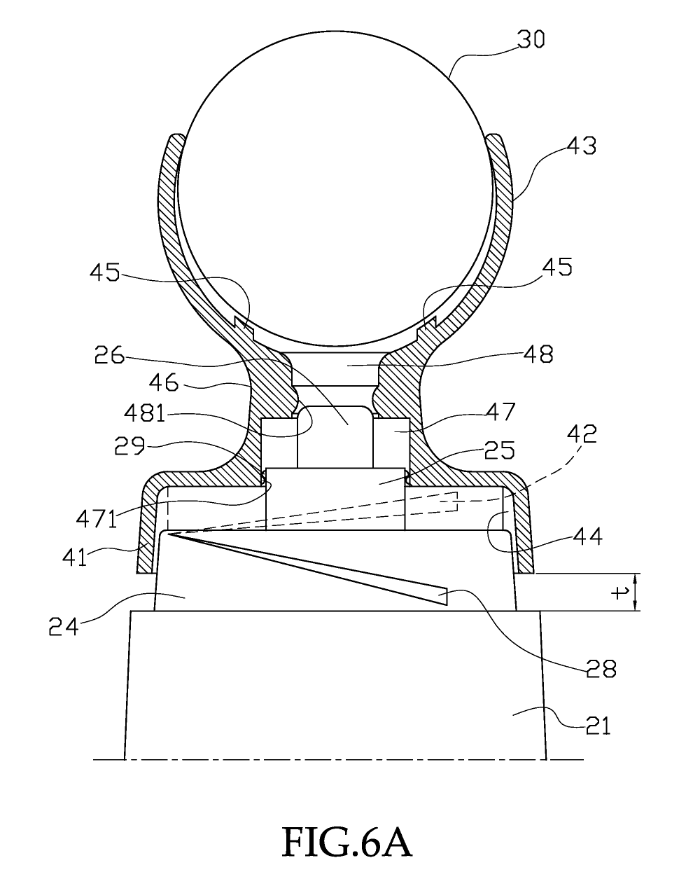

The ball seat 40 has a connecting portion 46 between the ball receiver 43 and the slipping-over cover 41. The connecting portion 46 has a first passage way 47 and a second passage way 48; the first passage way 47 is located at a lower position, while the second passage way 48 is located at an upper position. The radius of the first passage way 47 is larger than that of the nozzle 25 of the connecting seat 20, the first passage way 47 is provided on its bottom with a circle of stop annulus 471 to form a stopping action together with the circle of stop annulus 29 on the top end of the nozzle 25 to limit the displace stroke of the ball seat 40 relative to the connecting seat 20 (referring to FIGS. 5 and 6). The radius of the second passage way 48 is larger than that of the stop post 26 of the connecting seat 20, the second passage way 48 is provided therein with a soft washer 481 of which the inner radius is smaller than that of the stop post 26; a stop means is formed from the second passage way 48, the soft washer 481 and the stop post 26.

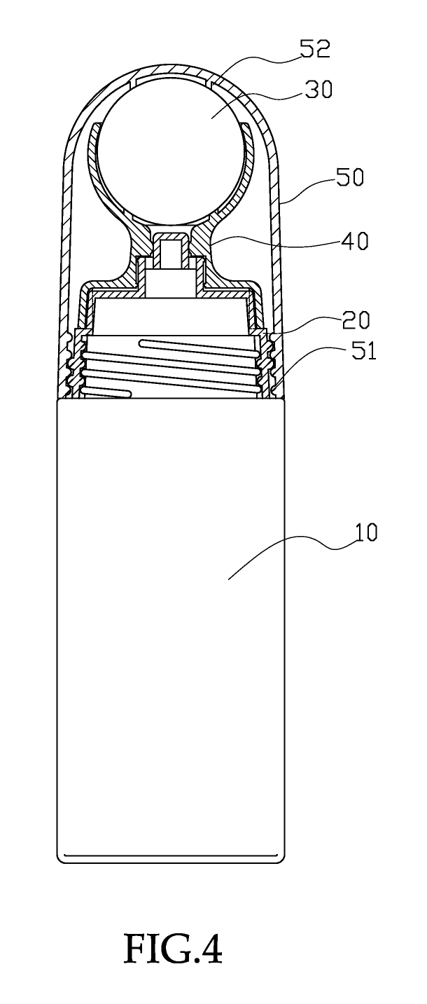

Referring to FIG. 4, the cap 50 is provided on its inner wall with a thread 51 that can be screw connected with the outer thread 23 on the base 21 of the connecting seat 20, thereby the cap 50 covers the bottle 10 to seal the ball seat 40, the ball 30 and the connecting seat 20. Meantime, the cap 50 is provided on its top with a circle of pressure annulus 52; when the bottle 10 is covered, the pressure annulus 52 will contact the ball 30 to position the latter and to prevent the same from rolling.

In using the present invention, the cap 50 can be removed to reveal the ball seat 40, the ball 30 and the connecting seat 20 as is shown in FIG. 5. Referring also to FIG. 5A, the bottom inclining surface 281 and the top inclining surface 421 respectively of the upper inclining rib 28 and the lower inclining rib 42 forming the displacement means are in their completely contacting positions, this forms a first kind of relative position after displacement between the connecting seat 20 and the ball seat 40, i.e., the top surface of the base 21 of the connecting seat 20 is contacted with the bottom surface of the slipping-over cover 41 of the ball seat 40. At this time, the stop post 26 of the connecting seat 20 is extended into the second passage way 48 of the ball seat 40 to make contact of the soft washer 481 with the stop post 26; thus the second passage way 48 is sealed to prevent the liquid for applying in the bottle 10 from flowing out.

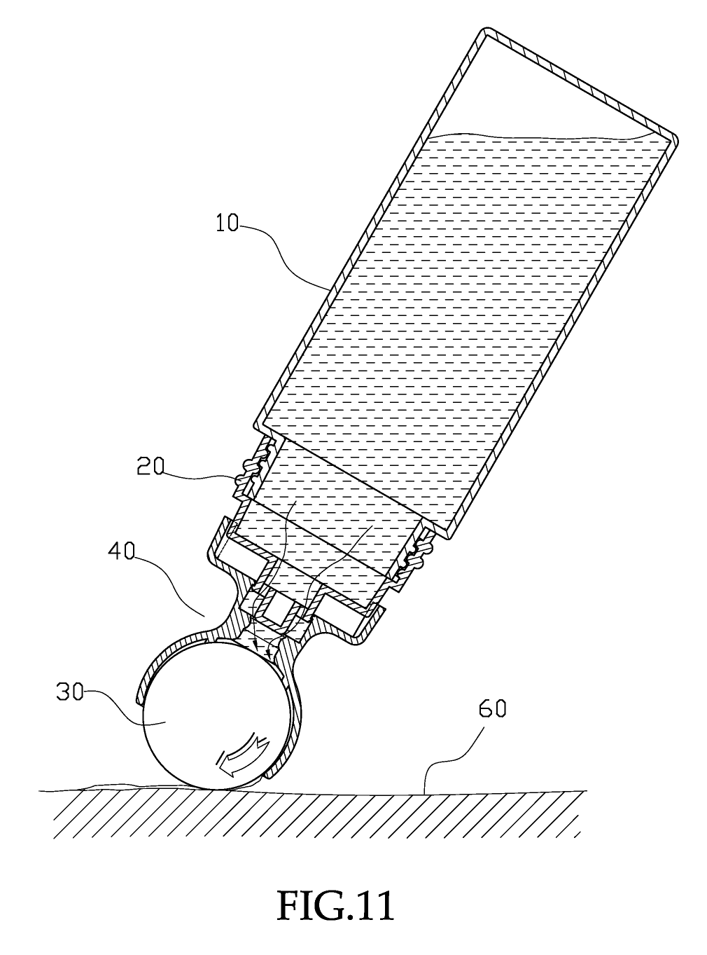

If the ball seat 40 is exerted with a rotating force to rotate relative to the connecting seat 20, the upper inclining rib 28 and the lower inclining rib 42 of the displacement means start to separate from each other, so that the ball seat 40 is raised relative to the connecting seat 20 to form a second kind of relative position after displacement as shown in FIG. 6; that is, the top surface of the base 21 of the connecting seat 20 is kept a gap “t” from the bottom surface of the slipping-over cover 41 of the ball seat 40. At this time, the e stop post 26 has been drawn out of the second passage way 48 to make opening of the latter, thereby the liquid for applying can flow through the second passage way 48 to the bottom of the ball 30 as is shown by arrows in FIG. 6. As shown in FIG. 11, now the ball 30 contacts an object 60 to be applied to (such as skin), thereby the ball 30 contacts the supporting protrusions 45, the liquid for applying can flow through a gap between the ball 30 and the ball receiver 43 with the help of rolling of the ball 30 to flow to the surface of the object 60 to be applied to.

When in the second relative position after displacement, the stop annulus 29 on the nozzle 25 of the connecting seat 20 gets close to the stop annulus 471 of the first passage way 47 to prevent separation of the connecting seat 20 from the ball seat 40, and to limit the maximum displacement of the connecting seat 20 from the ball seat 40; a position limiting means is formed from the stop annulus 29 on the nozzle 25 of the connecting seat 20 and the stop annulus 471 of the first passage way 47. And the two soft positioning blocks 44 of the positioning means are exactly engaged in the positioning cuts 241, thereby the connecting seat 20 and the ball seat 40 get an effect of positioning.

The liquid for applying flows out of the bottle 10 through the base 21 of the connecting seat 20, the nozzle 25 and the through holes 27 around the stop post 26 to slowly flow into the first passage way 47 and the second passage way 48 of the ball seat 40, then is carried by the rollable ball 30 out of the ball receiver 43 for the convenience of applying liquid.

The positioning blocks 44 in the slipping-over cover 41 of the ball seat 40 are tightly contacted with the outer surface of the protruding top seat 24 of the connecting seat 20, their function is to provide retarding force when in mutual rotating of the ball seat 40 relative to the connecting seat 20 for raising the ball seat 40, in order to prevent undesired opening of the stop means when in mutual rotating of the ball seat 40 relative to the connecting seat 20 effected by vibration against the applying container during storage or being not in use. And when the ball seat 40 and the connecting seat 20 are rotated to form the second relative position, the positioning blocks 44 are exactly engaged in the positioning cuts 241 to get the effect of positioning; and when the ball 30 is contacted by the object 60 to be applied to give it pressure, the ball seat 40 is prevented from lowering relative to the connecting seat 20 to thereby keep the stop means in its open state for the convenience of applying liquid.

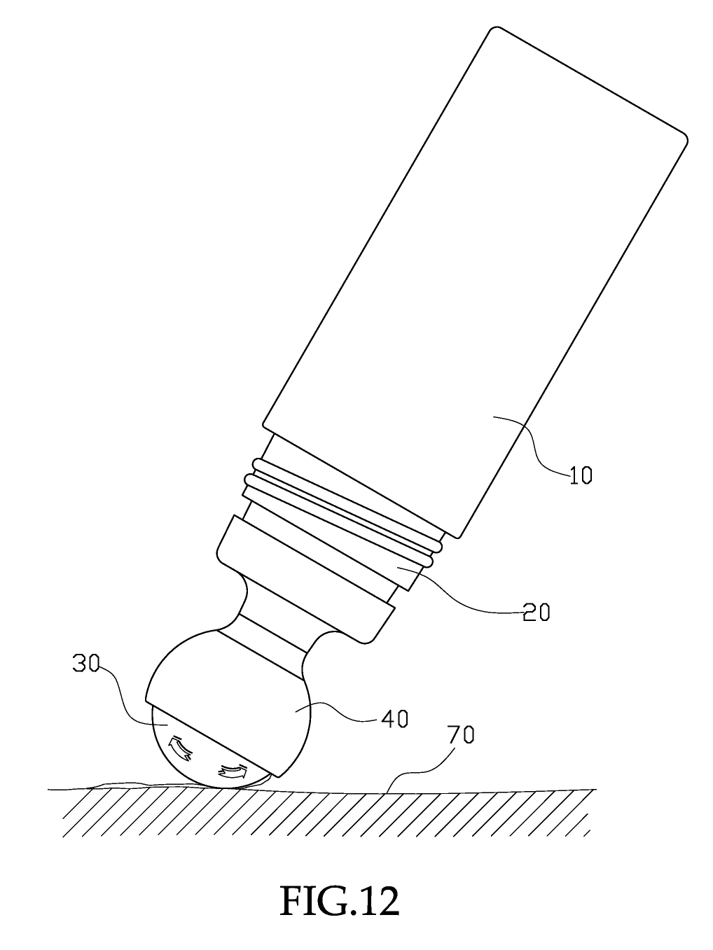

When the applying container to the present invention is used as a massaging tool, as shown in FIG. 12, the ball seat 40 and the connecting seat 20 are in the first relative position, while the stop means is in its close state, thereby the liquid for applying in the bottle 10 will not flow out by passing the ball 30. By the fact that the ball 30 can roll freely, it contacts the surface of the object 70 to be massaged; thus a massaging function is obtained.

Obviously, the applying container to the present invention is added with a massaging function as compared with the prior art, it is patentable accordingly. While the embodiment given is only for illustrating the present invention, and not for giving any limitation to the scope of the present invention; it will be apparent to those skilled in this art that various modifications or changes, such as some other type of displacement means or stop means without departing from the spirit of this invention, shall also fall within the scope of the appended claims.

1. An improved structure of container for applying liquid comprising:
a bottle having an opening and receiving therein liquid for applying;
a connecting seat connecting with said opening of said bottle;
a ball seat connecting with said connecting seat and having thereon a ball receiver and passage ways to communicate said connecting seat and said ball receiver;
a ball received in said ball receiver in a mode adapted to rolling, more than half of said ball being received in said ball receiver and a remaining part of said ball being exposed out of said ball receiver;
a displacement means formed on said connecting seat and said ball seat, said connecting seat and said ball seat forming between them a first kind of relative position after displacement and a second kind of relative position after displacement when in operation; and
a stop means provided in one of said passage ways of said ball seat;
when said connecting seat and said ball seat are in said first relative position after displacement, said stop means forms a closing state, then said liquid for applying in said bottle is prevented from flowing out of said ball, by contact of said ball with skin, a massaging function is obtained; when said connecting seat and said ball seat are in said second relative position after displacement, said stop means is opened, thus said liquid for applying in said bottle flows through said connecting seat to said ball at a top of said ball seat and flows outwards, and thereby an applying function is obtained.

2. The improved structure of container for applying liquid as claimed in claim 1, wherein said structure further comprises a position limiting means provided between said connecting seat and said ball seat and used to limit difference in distance of said first relative position from said second relative position.

3. The improved structure of container for applying liquid as claimed in claim 1, wherein said structure further comprises a positioning means provided between said connecting seat and said ball seat, so that when said displacement means is operated to render said connecting seat and said ball seat to be in said second relative position, said connecting seat and said ball seat are kept in said second relative position.

4. The improved structure of container for applying liquid as claimed in claim 1, wherein said displacement means includes an upper inclining rib provided on an outer wall of said connecting seat and a lower inclining rib provided on an inner wall of said ball seat, said upper inclining rib has a bottom inclining surface, said lower inclining rib has a top inclining surface; in operation, said bottom inclining surface and said top inclining surface are moved to contact with each other, and said connecting seat and said ball seat get said first and said second relative positions.

5. The improved structure of container for applying liquid as claimed in claim 4, wherein said bottle has on its upper end a thread portion for screw connecting with an inner thread of said connecting seat to connect said bottle with said connecting seat.

6. The improved structure of container for applying liquid as claimed in claim 5, wherein said connecting seat has a base, said inner thread is provided on an inner wall of said base; said base has thereon a protruding top seat, said protruding top seat is formed thereon a nozzle with a diameter smaller than that of said protruding top seat, said ball seat has on its bottom a slipping-over cover which is slipped over said protruding top seat of said connecting seat; when said slipping-over cover is rotated relatively to said protruding top seat to displace said displacement means, said first and second relative positions are formed.

7. The improved structure of container for applying liquid as claimed in claim 6, wherein said upper inclining rib of said displacement means is provided on an outer wall of said protruding top seat on said connecting seat, and said lower inclining rib is provided on an inner wall of said slipping-over cover of said ball seat.

8. The improved structure of container for applying liquid as claimed in claim 7, wherein said slipping-over cover is further provided on its inner wall with two positioning blocks, and a pair of positioning cuts are correspondingly provided on said protruding top seat, when said ball seat and said connecting seat are rotated to form said second relative position, said positioning blocks are exactly engaged in said positioning cuts to get an effect of positioning for said ball seat and said connecting seat to thereby be kept in said second relative position.

9. The improved structure of container for applying liquid as claimed in claim 8, wherein said ball receiver on said ball seat is in a form of a hopper, said ball receiver in said form of a hopper has a pair of supporting protrusions allocated symmetrically for supporting a bottom surface of said ball.

10. The improved structure of container for applying liquid as claimed in claim 9, wherein said ball seat has a connecting portion between said ball receiver and said slipping-over cover, said connecting portion forms therein said passage ways, said passage ways include a first passage way and a second passage way; said first passage way is located at a lower position, while said second passage way is located at an upper position; radius of said first passage way is larger than that of a nozzle of said connecting seat, said first passage way is provided on its bottom with a circle of stop annulus to form a stopping action together with a circle of stop annulus on a top end of said nozzle to limit displace stroke of said ball seat relative to said connecting seat to thereby form a position limiting means.

11. The improved structure of container for applying liquid as claimed in claim 10, wherein radius of said second passage way is larger than that of a stop post provided on said nozzle of said connecting seat, said second passage way is provided therein with a soft washer of which an inner radius is smaller than that of said stop post; said stop means is formed from said second passage way, said soft washer and said stop post, thereby when said displacement means is in said first relative position said stop post is extended into said second passage way to make contact of said soft washer with said stop post, thus said second passage way is sealed.

12. The improved structure of container for applying liquid as claimed in claim 10, wherein said stop post and said nozzle are formed therebetween a plurality of through holes for passing of liquid for applying.

13. The improved structure of container for applying liquid as claimed in claim 1, wherein said structure comprises a cap for covering said ball seat, said ball and said connecting seat.

14. The improved structure of container for applying liquid as claimed in claim 13, wherein said cap is provided on its top with a circle of pressure annulus; when said cap covers said bottle, said pressure annulus contacts said ball to position said ball and to prevent said ball from rolling.
